(19) United States
(12) Patent Application Publication
(10) Pub. No.: US 2013/0314938 A1
(43) Pub. Date: Nov. 28, 2013

(54) IN-VEHICLE INDOOR ILLUMINATION APPARATUS

(71) Applicants: Yasuo Suzuki, Shizuoka (JP); Shinji Yamada, Kanagawa (JP); Hirohito Toriyama, Kanagawa (JP)

(72) Inventors: Yasuo Suzuki, Shizuoka (JP); Shinji Yamada, Kanagawa (JP); Hirohito Toriyama, Kanagawa (JP)

(73) Assignee: Yazaki Corporation, Tokyo (JP)

(21) Appl. No.: 13/982,128

(22) PCT Filed: Feb. 15, 2012
(86) PCT No.: PCT/JP2012/054176

§ 371 Date: Jul. 26, 2013

(30) Foreign Application Priority Data
Feb. 15, 2011 (JP) 2011-030101

(51) Int. Cl. F21S 8/10

(52) U.S. Cl. CPC F21S 48/31
USPC 362/546

(57) ABSTRACT

The in-vehicle indoor illumination apparatus which includes a design section, a functional section that is engaged with the design section, and a connector that is inserted to the functional section in a removable manner, wherein an interposition holder of the functional section is provided with two locking frames erected upward from a base housing of the design section at an interval and having resilience, and two locking hooks each engaged with the two locking frames of the design section from outside the two locking frames when the functional section is engaged with the design section, and a section between the two second locking frames is a connector insertion hole into which a housing of the connector is inserted.

### TECHNICAL FIELD

The present invention relates to an in-vehicle indoor illumination apparatus in which a join between a design section and a functional section is not released even if a strong impact is received. Particularly, the present invention relates to an in-vehicle indoor illumination apparatus that is able to improve assembly strength of a room lamp even if an additional component is not used.

### BACKGROUND ART

As an in-vehicle indoor illumination apparatus, an apparatus is known which is joined by engaging a design section provided at an indoor side with a functional section provided at an outdoor side with an indoor ceiling plate of a vehicle interposed therebetween. In the in-vehicle indoor illumination apparatus, when joining the design section with the functional section, a locking hook provided on a side surface of the design section side and protruded to a side part is engaged by a target locking section that is installed at the functional section side in a direction parallel to the ceiling plate and has resilience.

However, for example, in a case where the target locking section of the functional section side receives the strong impact when a curtain airbag or the like is operated, the target locking section is bent, and there was a possibility that the joining between the design section and the functional section is released. For this reason, there was a possibility that a disadvantage is generated in which the design section falls in the indoor of the vehicle and is scattered. Thus, an in-vehicle indoor illumination apparatus is suggested in which the joining between the design section and the functional section is not released even if a strong impact is received, and which is able to prevent the design section falling and being scattered in the indoor (see PTL 1).

### CITATION LIST

[PTL 1] JP-A-2009-143531

### In-Vehicle Indoor Illumination Apparatus Described in PTL 1

FIG. 10 is an exploded perspective view of an in-vehicle indoor illumination apparatus described in PTL 1. In FIG. 10, the in-vehicle indoor illumination apparatus 100 is assembled by joining a design section 200 placed at an indoor side (a lower side of a ceiling plate 500) and a functional section 300 provided at an outdoor side (an upper side of the ceiling plate 500) via an attachment hole 501 of the ceiling plate 500 with the ceiling plate 500 of the indoor of a vehicle interposed therebetween. At that time, a target locking section 301 (not shown in the drawings) installed at the functional section 300 side in a direction parallel to the ceiling plate 500 and having resilience is engaged with a locking hook 201 that is protruded to the side part provided on the side surface of the design section 200. Specifically, the target locking section 301 climbs over the locking hook 201 in the bent state, and the bending of the target locking section 301 climbed over the locking hook 201 is returned by resilience, whereby both components are engaged with each other. Furthermore, a spacer insertion space 302 is provided outside the target locking section 301 of the functional section 300, and by inserting an insertion plate section 401 of a spacer 400 into the spacer insertion space 302 from above in a direction indicated by an arrow, the insertion plate section 401 of the spacer 400 restricts an engagement part between the locking hook 201 and the target locking section 301 from the outside so as not to bend the target locking section 301, and thus, the joining is not released even when impact is applied.

### Drawback of In-Vehicle Indoor Illumination Apparatus of PTL 1

In the in-vehicle indoor illumination apparatus of PTL 1, there is a need for a spacer 400 for an improvement in lamp assembly strength, but the spacer 400 is a cause of an increase in cost since the spacer 400 is a separate component.

### SUMMARY OF INVENTION

### Technical Problem

The present invention has been made in view of the drawbacks. It is an object of the present invention to provide an in-vehicle indoor illumination apparatus that is able to improve lamp attachment strength even if a spacer is not used when converting from a pressing method to a bus bar contact of the related art to a connector method.

### Solution to Problem

In order to achieve the object, a first aspect of the invention relates to an in-vehicle indoor illumination apparatus, comprising a design section including a base housing, a functional section engaged with the design section, and a connector inserted to the functional section in a removable manner, wherein an interposition holder of the functional section is provided with two locking frames erected upward from the base housing at an interval and having resilience, and two locking hooks each engaged with the two locking frames of the design section from outside the two locking frames when the functional section is engaged with the design section, and a section between the two second locking frames includes a connector insertion hole into which a housing of the connector is inserted.

According to a second aspect of the present invention, in the first aspect of the invention, the functional section is provided with a connector locking frame that regulates one side of the connector insertion hole.

### Advantageous Effects of Invention

As mentioned above, according to the present invention, by inserting the connector into the connector insertion hole formed by the engagement between the locking frame of the design section with the locking hook of the functional section, the connector prevents the locking frame of the design section warping inward. Thus, it is possible to attain an in-vehicle indoor illumination apparatus in which the joining is not released, and it is possible to improve lamp attachment strength even if a spacer is not used which was a problem of an apparatus of the related art.

Furthermore, by providing the connector locking frame regulating one side of the connector insertion hole in the functional section, the connector insertion hole can be further strengthened.

### BRIEF DESCRIPTION OF THE DRAWINGS

FIG. 1A is a perspective view in which an in-vehicle indoor illumination apparatus according to the present invention is viewed from below, and FIG. 1 B is an exploded perspective view that shows the in-vehicle indoor illumination apparatus of FIG. 1A.

FIG. 2A is a perspective view in which the in-vehicle indoor illumination apparatus of FIG. 1A is viewed from above, and FIG. 2B is an exploded perspective view that shows the in-vehicle indoor illumination apparatus of FIG. 2A.

FIG. 3 is an exploded perspective view of a functional section.

FIG. 4A is a front cross-sectional view that shows a state in which the in-vehicle indoor illumination apparatus according to the present invention is disassembled, and FIG. 4B is a side cross-sectional view thereof.

FIGS. 5A, 5D, 5B, 5E, 5C and 5F are diagrams that shows a step of sequentially assembling a lamp of a disassembled state of FIGS. 4A and 4B in three steps of (1) to (3), FIGS. 5A, 5B and 5C are front cross sectional views, and FIGS. 5D, 5E and 5F are side cross-sectional views.

FIGS. 6A, 6B and 6C are side cross-sectional views that shows a step of inserting a connector into the in-vehicle indoor illumination apparatus assembled in FIGS. 5D, 5E and 5F in three steps of (1) to (3).

FIG. 7 is an exploded perspective view in which the exploded perspective view of the in-vehicle indoor illumination apparatus of FIG. 2B is viewed from the connector side.

FIGS. 8A and 8B are perspective views when inserting the connector into the in-vehicle indoor illumination apparatus assembled by the exploded perspective view of FIG. 7, FIG. 8A is a perspective view before the insertion, and FIG. 8B is a perspective view after the insertion.

FIG. 9A is a front view in which the in-vehicle indoor illumination apparatus of FIG. 8B is viewed from the connector side, and FIG. 9B is a longitudinal cross-sectional view in which the in-vehicle indoor illumination apparatus of FIG. 9A is longitudinally cut through a second locking hook and a second locking frame.

FIG. 10 is an exploded perspective view of the in-vehicle indoor illumination apparatus described in PTL 1.

### DESCRIPTION OF EMBODIMENTS

### Configuration of In-Vehicle Indoor Illumination Apparatus of the Present Invention

An in-vehicle indoor illumination apparatus according to the present invention capable of improving lamp assembly strength even if not using a spacer, which is a separate component, will be described below.

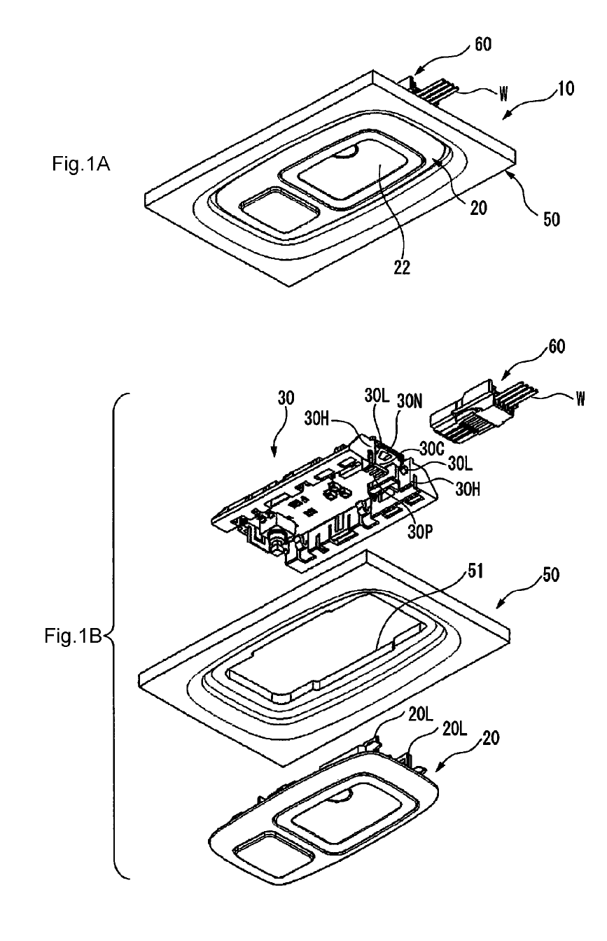

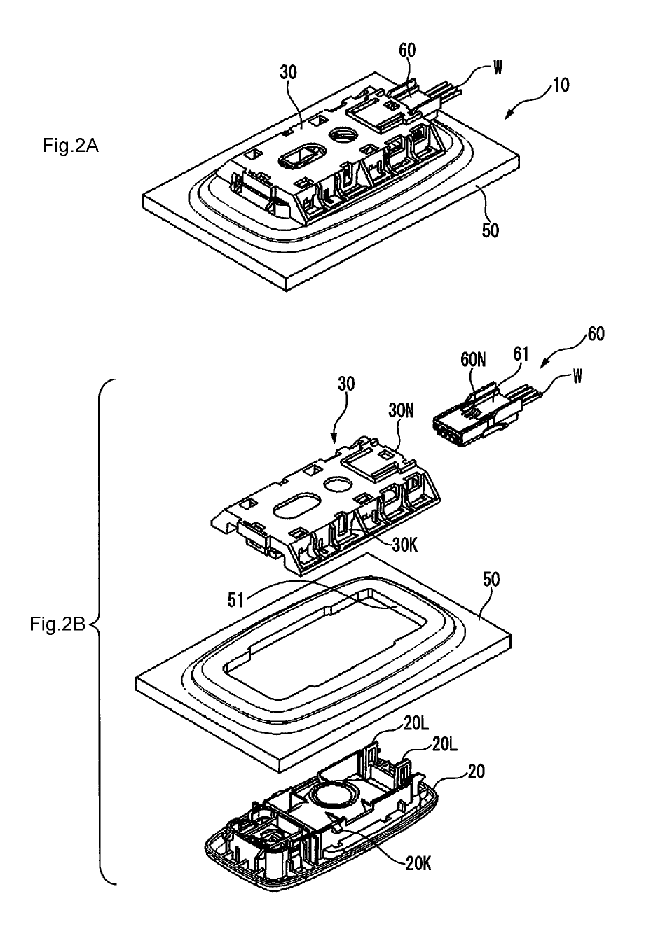

FIG. 1A is a perspective view in which an in-vehicle indoor illumination apparatus according to the present invention is viewed from below, and FIG. 1 B is an exploded perspective view that shows the in-vehicle indoor illumination apparatus of FIG. 1A. FIG. 2A is a perspective view in which the in-vehicle indoor illumination apparatus of FIG. 1A is viewed from above, and FIG. 2B is an exploded perspective view that shows the in-vehicle indoor illumination apparatus of FIG. 2A.

In FIGS. 1A, 1B, 2A and 2B, the in-vehicle indoor illumination apparatus 10 includes a design section 20 (FIGS. 1A and 1B), a functional section 30 (FIGS. 2A and 2B), and a connector 60 (FIGS. 1A, 1B, 2A, 2B) connected to the functional section 30.

### Design Section 20

The design section 20 includes a base housing, a transparent or opaque lens cover that can be attached to or detached from a lower surface side of the base housing, and a switch knob.

### Engagement Mechanism of Design Section 20

The design section 20 is provided with second locking frames 20L and 20L (FIG. 2B) according to the present invention erected upward from the base housing 21 and having resilience (elasticity) on the side surface of the base housing 21, in addition to a first locking hook 20K (FIG. 2B) present from the past. The first locking hook 20K is engaged with a first locking frame 30K (FIG. 2B) of the functional section 30, and the second locking frame 20L according to the present invention is engaged with a second locking hook 30L (FIG. 1B) of the related art according to the present invention of the functional section 30.

### Functional Section 30

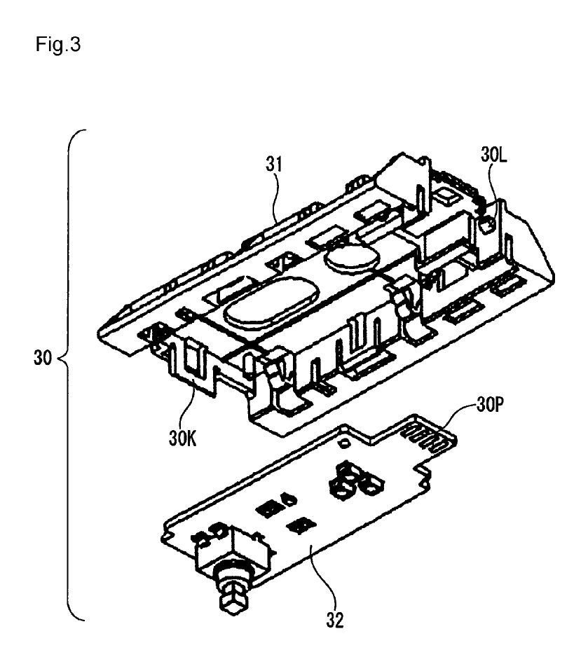

FIG. 3 is an exploded perspective view of the functional section 30. In FIG. 3, the functional section 30 includes an interposition holder 31, and a circuit board 32 with an electronic component installed thereon, a connection pad 30P is provided in an end portion of the circuit board 32, and a connector insertion hole 30C (FIG. 1B) according to the present invention is formed by engaging the design section 20 with the functional section 30 (described later). By inserting a connector 60 (FIG. 1B) into the connector insertion hole 30C, the connection pad 30P and a terminal of the connector 60 are electrically connected to each other.

### Engagement Mechanism of Functional Section 30

The functional section 30 includes the first locking frame 30k (FIGS. 2B and 3) of the related art engaged with the first locking hook 20K (FIG. 2B) of the design section 20 on the side surface of the interposition holder 31, and in addition, the second locking hook 30L (FIGS. 1B and 3) according to the present invention engaged with the second locking frame 20L (FIG. 1B) mentioned above of the design section 20 is included inside the interposition holder 31.

In addition, a connector locking frame 30N (a third target locking section, FIGS. 1B and 2B) is provided near (although being provided upside in the present embodiment, there is no need to be limited to the upside) connector insertion hole 30C of the functional section 30. A locking hook 60N (a third locking section, FIG. 2B) of the connector described later is engaged with the connector locking frame 30N.

### Connector 60

The connector 60 (FIGS. 1B and 2B) is constituted by a connector housing 61 (FIG. 2B) including the locking hook 60N (the third locking section, FIG. 2B) having resilience, and a terminal (not shown in the drawings) connecting and holding an electric wire W.

### Engagement Mechanism of Connector 60

When inserting the connector 60 into the connector insertion hole 30C (FIG. 1B) formed in the functional section 30, the locking hook 60N of the connector 60 is engaged with the connector locking frame 30N (FIGS. 1B and 2B) of the functional section 30, which prevents the disengagement of both after that.

### Attachment of In-Vehicle Indoor Illumination Apparatus 10 to Ceiling Plate 50

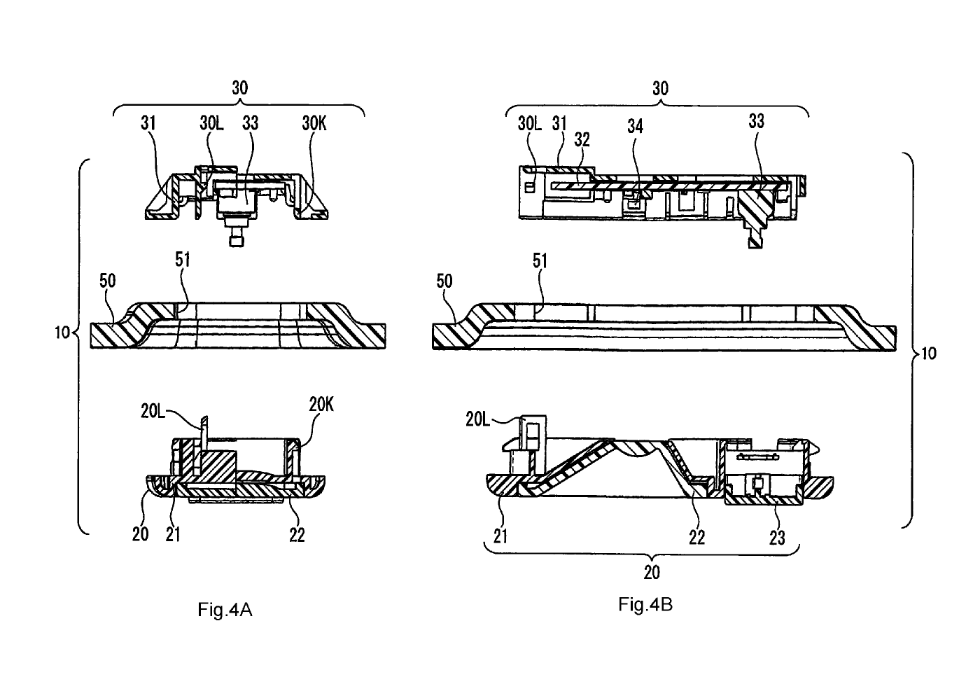

Next, a sequence will sequentially be described by the use of FIGS. 4A to 9B until the design section 20 and the functional section 30 mentioned above are attached to the ceiling plate 50, and the connector 60 is attached to the functional section 30 to complete the attachment of the in-vehicle indoor illumination apparatus 10.

### Step 1: State in Which In-Vehicle Indoor Illumination Apparatus 10 is Disassembled

FIG. 4A is front cross-sectional view showing a state in which the in-vehicle indoor illumination apparatus according to the present invention is not assembled but is disassembled, and FIG. 4B is a side cross-sectional view thereof.

In FIGS. 4A and 4B, before being attached to the ceiling plate 50, the design section 20 exists at the lower side, and the functional section 30 exists at the upper side with the ceiling plate 50 interposed therebetween.

The design section 20 includes the base housing 21, the transparent or opaque lens cover 22 that can be attached to or detached from the lower surface side of the base housing 21, and the switch knob 23 (FIG. 4B). On the side surface of the base housing 21, the first locking hook 20K (FIG. 4A), and the second locking frame 20L according to the present invention erected upward from the base housing 21. The first locking hook 20K forms a taper having a transverse width gradually expanded from a taper backward from the upper side of the tip in the engagement direction, and a key shape returning in the end portion of the taper at right angle.

The second locking frame 20L is a flat rectangular member, is formed with a square opening at the upper side there, and includes resilience since the same is formed of an elastic material.

When the lower design section 20 and the upper functional section 30 are assembled with each other with the ceiling plate 50 interposed therebetween, the switch 33 of the functional section 30 is received in the switch knob 23, and the switch 33 is operated by pressing the switch knob 23 or causing the same to slide.

The functional section 30 includes the interposition holder 31 and the circuit board 32 (FIG. 4B) with an electronic component installed thereon. Furthermore, the functional section 30 is provided with the switch 33 and a light source 34 (FIG. 4B) at the lower surface side thereof. When assembling the design section 20 with the functional section 30 via the ceiling plate 50, the lens cover 22 faces the light source 34 so as to cover the same, and the switch 33 is received in the switch knob 23.

### Step 2: Firstly, Locating Design Section 20 in Attachment Port 51 of Ceiling Plate 50

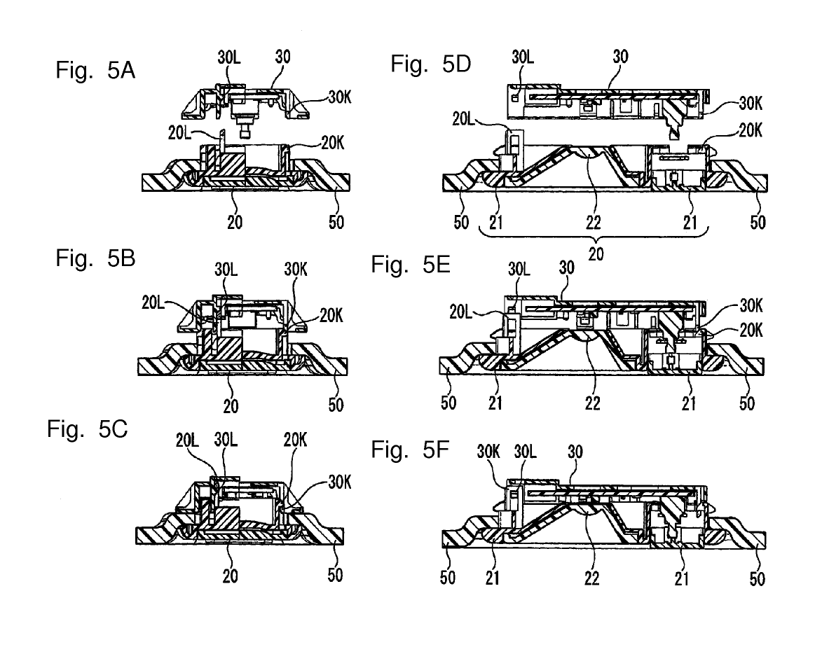

FIGS. 5A, 5D, 5B, 5E, 5C and 5F are diagrams in which a step of sequentially assembling the lamp of the disassembled state of FIGS. 4A and 4B by three stages of (1) to (3), FIGS. 5A, 5B and 5C are front cross-sectional views thereof, and FIGS. 5D, 5E and 5F are side cross-sectional views thereof.

Firstly, FIGS. 5A and 5D are diagrams that show the state of installing the design section 20 in the attachment port 51 (FIGS. 1A and 1B) of the ceiling plate 50. In FIGS. 5A and 5D, the tip portion is inserted and installed to the attachment hole 51 (FIGS. 1B and 2B) of the ceiling plate 50 to leave a peripheral edge of the base housing 21 (FIGS. 4A and 4B) of the design section 20.

### Step 3: Causing Each Engagement Section of Design Section 20 and Functional Section 30 to Approach Each Other

FIGS. 5B and 5E are diagrams showing the state causing each engagement section of the design section 20 and the functional section 30 to approach each other with the ceiling plate 50 interposed therebetween. In FIGS. 5B and 5E, the taper of the first locking hook 20K of the design section 20 comes into contact with the first locking frame 30K of the functional section 30, and the second locking frame 20L of the design section 20 comes into contact with the taper of the second locking hook 30L of the functional section 30, whereby a state is obtained that is just before the tapers of each locking hook, having resilience, are about to climb over the edge of the counterpart locking frame.

### Step 4: Each Engagement Section of Design Section 20 and Functional Section 30 is Engaged with Each Other

FIGS. 5C and 5F are diagrams showing the state in which each engagement section of the design section 20 and the functional section 30 is engaged with each other with the ceiling plate 50 interposed therebetween. FIGS. 5C and 5F, the taper of the first locking hook 20K of the design section 20 climbs over the edge the first locking frame 30K of the functional section 30 and is engaged with the openings of the first locking hook 20K and the first locking frame 30K. Furthermore, the taper of the second locking hook 30L of the functional section 30 climbs over the edge of the second locking frame 20L of the design section 20, and is engaged with the openings of the second locking hook 30L and the second locking frame 20L. The disengagement of the design section 20 and the functional section 30 after that is prevented by the engagement of the engagement section.

### Step 5: Connector 60 is Connected to In-Vehicle Indoor Illumination Apparatus 10

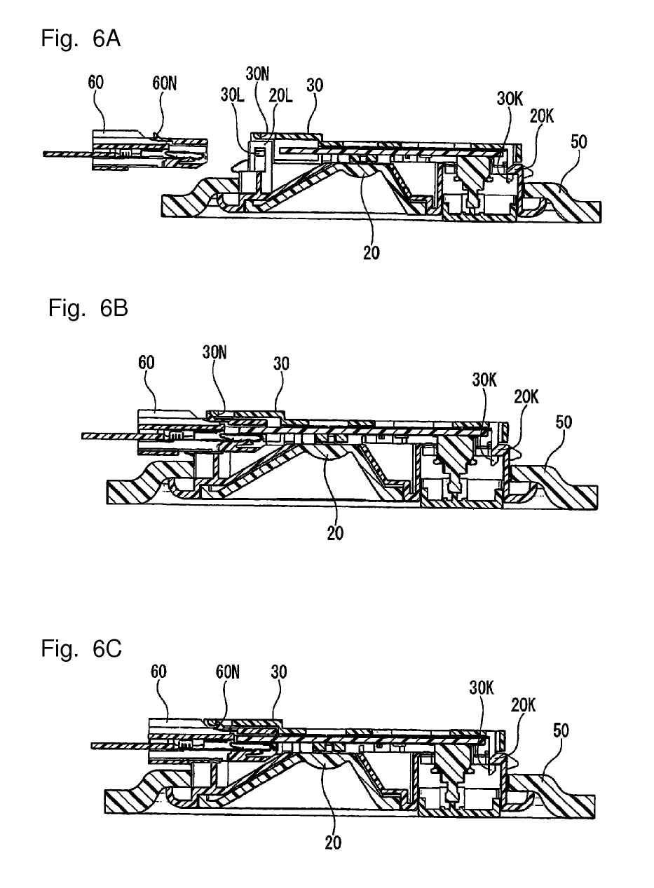

FIGS. 6A, 6B and 6C are side cross-sectional views that show the step of inserting the connector 60 to the in-vehicle indoor illumination apparatus 10 assembled in FIG. 5D-F by three steps of (1) to (3).

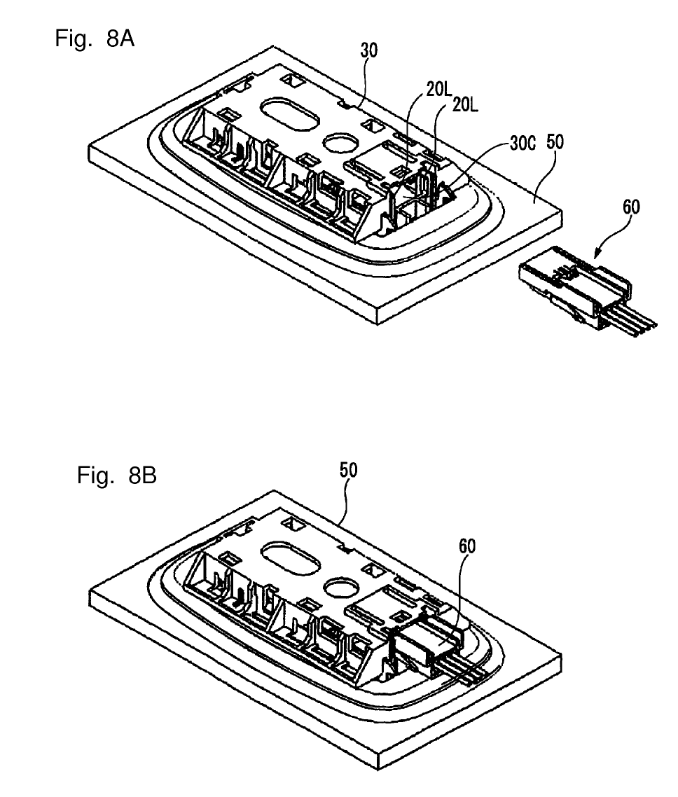

FIG. 6A is a side cross-sectional view that shows the state of causing the connector 60 to approach the in-vehicle indoor illumination apparatus 10. As shown in FIG. 6A, the second locking frame 20L of the design section 20 is engaged with the second locking hook 30L of the functional section 20, whereby a cavity section surrounded by the second locking frame 20L and the second locking hook 30L is formed, and the cavity section becomes the connector insertion hole 30C (FIG. 8A). The connector 60 is caused to horizontally approach the connector insertion hole 30C toward the locking hook 60N of the connector 60 to the connector locking frame 30N provided above the functional section 30.

### Step 6: Connector 60 is Inserted into Connector Insertion Hole 30C

FIG. 6B shows that the connector 60 is inserted into the connector insertion hole 30C, the taper of the locking hook 60N of the connector 60 comes into contact with the connector locking frame 30N of the functional section 30, and the taper of the locking hook 60N of the connector 60 climbs over the edge of the connector locking frame 30N of the functional section 30.

### Step 7: Connector 60 is Completely Inserted into Connector Insertion Hole 30C

FIG. 6C shows the state in which the taper of the locking hook 60N of the connector 60 climbs over the edge of the connector locking frame 30N of the functional section 30 and is engaged with the openings of the locking hook 60N and the locking frame 30N. The disengagement of both after that is prevented by the engagement.

As mentioned above, when inserting the connector 60 into the connector insertion hole 30C formed by the present invention, the locking hook 60N of the connector 60 is engaged with the connector locking frame 30N of the functional section 30, whereby the connection pad 30P (FIGS. 1B and 3) is electrically connected to the terminal of the connector 60.

### Completion of Connector Insertion Hole 30

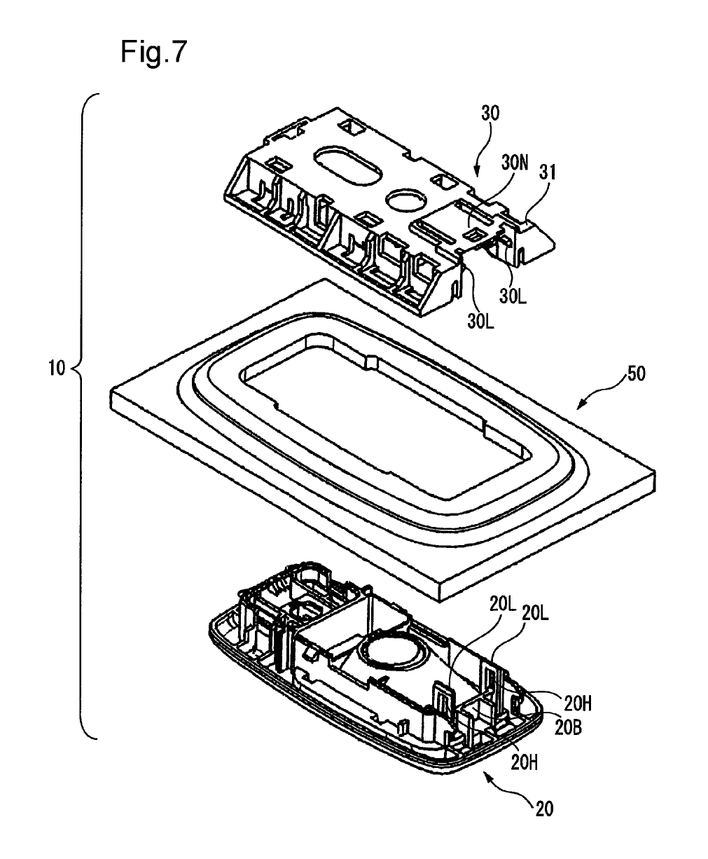

Next, a reason, in which the connector insertion hole 30C is completed by the engagement between the design section 20 and the functional section 30 according to the present invention, will be described in detail by the use of the perspective views of FIGS. 7, 8A and 8B.

FIG. 7 is an exploded perspective view in which the exploded perspective view of the in-vehicle indoor illumination apparatus of FIG. 2B is viewed from the connector side, FIGS. 8A and 8B are perspective views when assembling the exploded perspective view of FIG. 7 and inserting the connecter into the in-vehicle indoor illumination apparatus. FIG. 8A is a perspective view before the insertion, and FIG. 8B is a perspective view after the insertion.

In FIG. 7, in the design section 20, the two second locking frames 20L and 20L according to the present invention are erected from below at an interval at the front of the design section 20 (an connector insertion side). The second locking frame 20L has a thin, flat and rectangular shape having resilience, thin long holes 20H are provided in the middle thereof, and the two second locking frames 20L and 20L are erected so that the thin long holes 20H face each other. The lower sides of the second locking frames 20L and 20L are connected by the connection section 20B, thereby reinforcing the erection of the second locking frames 20L and 20L and forming the lower end of the connector insertion hole 30C.

Meanwhile, in the functional section 30, on the inner wall surface of the interposition holder 31, the second locking hooks 30L and 30L are provided face to face at an interval. The second locking hook 30L forms a taper having the transverse width gradually expanded from the tip upper side of the engagement direction toward the back side from the tapering, and a key shape returning at a right angle in the end portion of the taper.

Furthermore, the connector locking frame 30N is formed above the functional section 30, an opening is provided in the same, and the locking hook 60N provided above the housing of the connector 60 and having resilience is engaged with the same. There is no need to necessarily install the engagement position between the connector locking frame 30N of the functional section 30 and the locking hook 60N of the housing of the connector 60 above the connector 60.

### Before Insertion: FIG. 8B

Thus, when causing the design section 20 and the functional section 30 to approach each other with the ceiling plate 50 interposed therebetween, and engaging the second locking hook 30L of the functional section 30 with the second locking frame 20L of the design section 20, the in-vehicle indoor illumination apparatus of FIG. 8A is obtained. At this time, by the joining between the design section 20 and the functional section 30, the connector insertion hole 30C is completed as below. That is, an upper surface of the connector insertion hole 30C is formed with the connector locking frame 30N of the functional section 30, a lower surface of the connector insertion hole 30C is formed with the connection section 20B of the design section 20, the left and right side surfaces are formed with the second locking frames 20L and 20L of the design section 20, whereby a vertical and horizontal framework is completed as a whole.

### After Insertion: FIG. 8B

Thus, when inserting the connector 60 into the connector insertion hole 30C, the taper of the locking hook 60N of the connector 60 comes into contact with the connector locking frame 30N of the functional section 30, the taper of the locking hook 60N having resilience of the connector 60 vertically climbs over the connector locking frame 30N of the functional section 30 and reaches the opening, whereby the engagement between the connector 60 and the in-vehicle indoor illumination apparatus is completed as shown in FIG. 8B, and the disengagement of both after that is prevented.

### Two Effects of Connector Insertion hole 30C

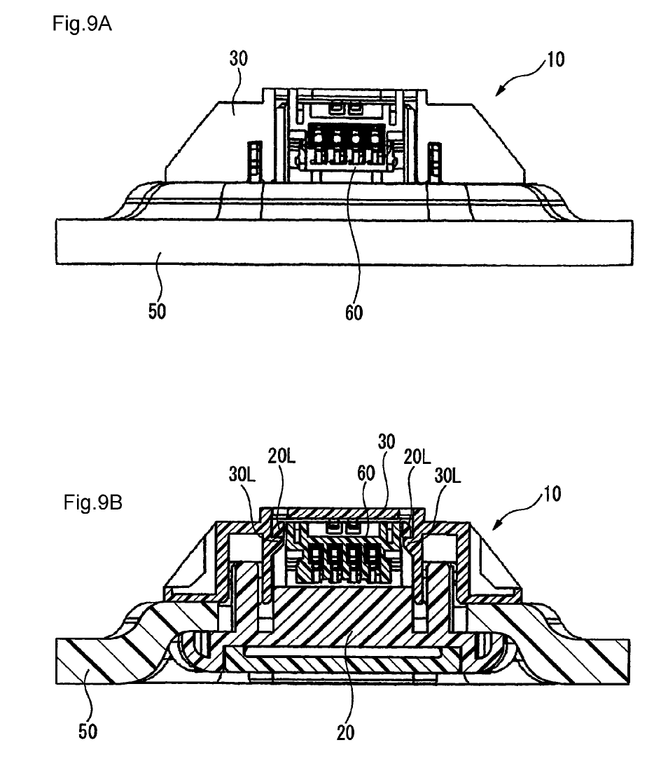

Two Effects (a half engagement detection and an engagement disengagement prevention) of the connector insertion hole 30C according to the present invention described above will be described by the use of FIGS. 9A and 9B. FIG. 9A is a front view in which the in-vehicle indoor illumination apparatus of FIG. 8B is viewed from the connector side, and FIG. 9B is a longitudinal cross-sectional view in which the in-vehicle indoor illumination apparatus of FIG. 9A is longitudinally cut through the second locking hook and the second locking frame.

### Effect 1: Half Engagement Detection

As is evident from the drawings, when the second locking frame 20L of the design section 20 is not completely engaged (half-engaged) with the second locking hook 30L of the functional section 30, since the second locking frame 20L is pressed inward by the second locking hook 30L, the cavity section is not generated into which the connector can be inserted. Thus, the connector 60 cannot be inserted into the connector insertion hole 30C. For this reason, the half engagement of the connector 60 can easily be found.

### Effect 2: Engagement Disengagement Prevention

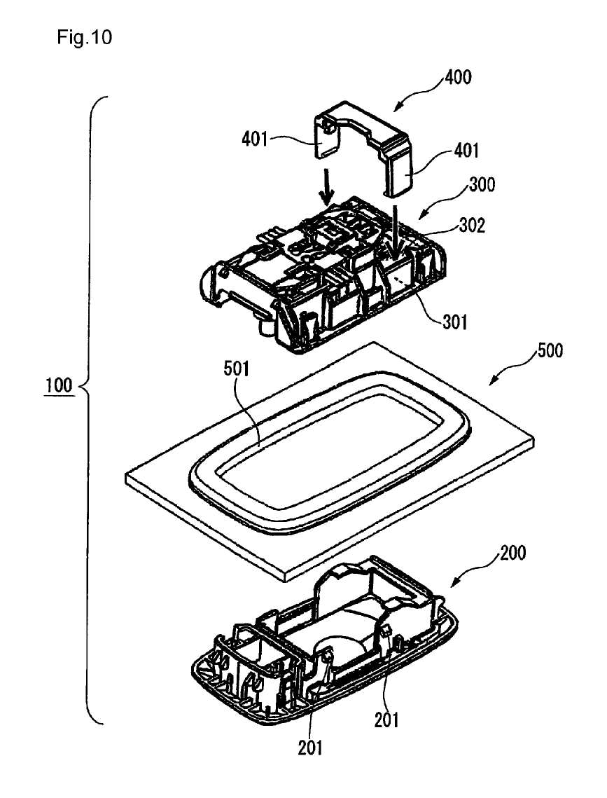

Furthermore, in a case where the connector 60 is inserted into the connector insertion hole 30C, since the connector 60 is inserted between the second locking frames 20L and 20L of the design section 20, the housing of the connector 60 prevents that the respective second locking frames 20L and 20L are bent inward, respectively. Thus, the engagement between the second locking frame 20L of the design section 20 and the second locking hook 30L of the functional section 30 is not disengaged. That is, by using the housing of the connector 60 for being naturally electrically connected to have the function of the spacer 400 (FIG. 10) of the related art, the spacer of the related art is unnecessary for the present invention.

### CONCLUSION

As mentioned above, according to the present invention, by inserting the connector into the connector insertion hole that is formed by engaging the second locking frame of the design section with the second locking hook of the functional section, the connector prevents the second locking frame L of the design section being bent inward. Thus, it is possible to obtain the in-vehicle indoor illumination apparatus in which the engagement is not disengaged and which is able to improve the lamp assembly strength even if not using the spacer that is the problem of the apparatus of the related art.

This application is based upon and claims the benefit of priority of Japanese Patent Application No. 2011-030101 filed on Feb. 15, 2011, the contents of which are incorporated herein by reference.

### INDUSTRIAL APPLICABILITY

As mentioned above, according to the present invention, by inserting the connector into the connector insertion hole formed by the engagement between the locking frame of the design section with the locking hook of the functional section, the connector prevents the locking frame of the design section warping inward. Thus, it is possible to attain an in-vehicle indoor illumination apparatus in which the joining is not released, and it is possible to improve lamp attachment strength even if a spacer is not used which was a problem of an apparatus of the related art.

1. An in-vehicle indoor illumination apparatus, comprising:
a design section including a base housing;
a functional section engaged with the design section; and
a connector inserted to the functional section in a removable manner;
wherein an interposition holder of the functional section is provided with two locking frames erected upward from the base housing at an interval and having resilience, and two locking hooks each engaged with the two locking frames of the design section from outside the two locking frames when the functional section is engaged with the design section, and a section between the two second locking frames includes a connector insertion hole into which a housing of the connector is inserted.

2. The in-vehicle indoor illumination apparatus according to claim 1, wherein the functional section is provided with a connector locking frame that regulates one side of the connector insertion hole.
